(19) United States
(12) Patent Application Publication
(10) Pub. No.: US 2022/0115654 A1
(43) Pub. Date: Apr. 14, 2022

(54) MIXED METAL MANGANESE OXIDE MATERIAL

(71) Applicant: UOP LLC, Des Plaines, IL (US)

(72) Inventors: Stuart R. Miller, Arlington Heights, IL (US); Susan C. Koster, Carpentersville, IL (US); Natalie L. Nicholls, Chicago, IL (US); Elmira Ghanbari, Wheeling, IL (US)

(21) Appl. No.: 17/349,037

(22) Filed: Jun. 16, 2021

Related U.S. Application Data
(60) Provisional application No. 63/091,395, filed on Oct. 14, 2020.

(51) Int. Cl. H01M 4/505; C01G 45/02; H01M 4/525; H01M 4/56; H01M 4/54; H01M 10/24

(52) U.S. Cl. CPC H01M 4/505; C01G 45/02; H01M 4/525; H01M 4/56; H01M 2004/028; H01M 10/24; C01P 2002/52; C01P 2002/72; C01P 2006/40; H01M 4/54

(57) ABSTRACT

A homogenously mixed metal manganese oxide. The mixed metal manganese oxide includes a homogenous mixture of manganese and at least two more metals. The additional metals may be cesium, nickel, copper, bismuth, cobalt, magnesium, iron, aluminum, scandium, vanadium, chromium, silver, gold, titanium, or, lead. A method of making the metal manganese oxide material includes mixing salts of manganese and the additional metals. The mixture may be activated and digested at an elevated temperature. Also, a battery having a cathode made from the homogenously mixed metal manganese oxide.

### RELATED APPLICATIONS

This application claims priority to U.S. Provisional Patent Application Ser. No. 63/091,395 filed on Oct. 14, 2020, the entirety of which is incorporated herein by reference.

### FIELD OF THE INVENTION

This invention relates generally to the storage of electrical energy, and more particularly to batteries, and even more specifically to a material for a cathode in a battery.

### BACKGROUND OF THE INVENTION

The efficient and cost-effective capture and storage of energy is critically important, in particular, the storage and use of electrical energy has become a cornerstone to our modern lives. From cellular phones and electric vehicles to the continual development, refinement and deployment of energy from renewable sources, electrochemical energy storage plays a pivotal role in our developing world and provides significant market opportunity.

Owing to its relative abundance, low cost, toxicity equilibrium potential, zinc rapidly became a key component in the fabrication of electrochemical cells. Zinc provides the benefit of high energy densities as well as being chemically compatible with aqueous electrolytes. Due to this, the electrochemical properties of zinc have been a long-standing fascination for over 200 years, with one of the first documented occurrences starting with Alessandro Volta, who, in 1798, is credited with the invention of the first true battery, consisting of a stacks of alternating copper and zinc disks separated by a layer of cloth or cardboard soaked in brine.

Since Volta's invention of the Voltaic pile, zinc has been a key component of several different battery technologies, however it was not until 1866 that French electrical engineer Georges Leclanché paired the electrochemical properties of zinc and manganese inventing the Leclanché cell. The Leclanché cell comprises of a zinc anode and a manganese dioxide (and carbon) cathode wrapped in a porous material and dipped in a vessel containing ammonium chloride, providing a voltage ˜1.4V. The Leclanché cell was further modified by German physicist Carl Gassner by mixing ammonium chloride and a small volume of zinc chloride, in plaster of Paris, immobilizing the electrolyte. The manganese dioxide cathode was dipped in the plaster of Paris paste and then encased inside a zinc cell, providing a potential of ˜1.5V. The system was referred to as the dry cell as there was no liquid electrolyte, which enabled the use of the dry cell in any orientation. Taking advantage of low material costs, the dry cell was mass produced until the late 1950s when it was replaced by Union Carbide's innovation, the modern Zn|MnO₂ alkaline battery. Zn|MnO₂ alkaline batteries are considered as primary batteries, i.e. non-rechargeable, as there is an irreversible transformation to the cell upon discharge.

The simplified electrochemical reactions which take place at the anode and the cathode are shown below:

Zn+2OH⁻→ZnO+H₂O+2e⁻ Anode (oxidation)

2MnO₂+H₂O+2e⁻→Mn₂O₃+2OH⁻ Cathode (reduction)

Zn+2MnO₂→ZnO+Mn₂O₃ Overall reaction

The manganese oxide cathode material used in the production of zinc batteries is electrolytic manganese dioxide (EMD) and can also be described as the γ-MnO₂ phase. Historically, the manganese oxide mineral Nsutite, was used as the cathode material in zinc-carbon dry cell batteries, however in recent years production EMD has enabled a more reliable MnO₂ source as well as enhanced performance and stability. Nsutite and EMD are both ingrown pyrolusite/Ramsdellite materials. It has been well demonstrated, the current Zn|MnO₂ batteries are limited in their ability to recharge owing to an irreversible transformation of the MnO₂ phase upon discharge to the dense phases of Mn₂O₃ and Mn₃O₄, a cartoon representation of which is shown below in FIG. 1. However, prior to the formation of these phases, it is understood that EMD undergoes as dissolution/recrystallization procedure involving the in-situ crystallization of δ-MnO₂.

Since the invention of the Zn|MnO₂ alkaline battery, there has been considerable efforts to provide a rechargeable solution to enable the recharge and reuse the of cell after the primary discharge. Rechargeable alkaline manganese (RAM) batteries were developed from primary alkaline battery technology and are capable of being recharged for a limited number of cycles at limited depth of discharge. In the 1970s, a collaborative effort between Union Carbide and Mallory resulted in the introduction of the first-generation of rechargeable alkaline batteries. Several companies and academic institutions pursued different routes to establishing rechargeable alkaline manganese oxide technologies however research interest in the area subsided with the commercialization of lithium-ion technology in 1991, a collaborative effort between Sony and Asahi Kasei. Since then lithium-ion batteries (LIBs) have established themselves as technology leaders assuming the dominant market share for rechargeable energy solutions.

For over 25 years, LIBs have cemented themselves as the rechargeable battery of choice, finding applications in technologies as diverse as portable electronics and electric vehicles to large scale energy storage complexes such as the 100-megawatt battery built by Tesla in South Australia.

Today, LIBs remain the rechargeable battery of choice, however there are several factors which bring into question its continued market dominance, including cost, durability and potential safety hazards. Over the last 60 years, Zn|MnO₂ alkaline cells have established themselves as a principal battery technology with an estimated $7.73B in global sales for consumer single use batteries by 2021. Modern Zn|MnO₂ alkaline batteries use cheap, abundant materials (Mn≈$0.45-0.9 kg) (Zn≈$0.45$kg) (K≈$0.1 kg) to provide safe batteries cells which are EPA certified for disposal.

The low material price enables the manufacture of primary Zn|MnO₂ alkaline batteries for $18-25 kWh, which makes them attractive for a variety of potential energy storage solutions if their chemistry could be altered to make them rechargeable.

Therefore, there remains a need for providing a rechargeable battery that utilizes the Zn|MnO₂ chemistry.

### SUMMARY OF THE INVENTION

The present invention provides crystalline, manganese-based, mixed metal oxides that are suitable for use as a cathode material for rechargeable batteries. The mixed metal oxides exhibit a diffraction pattern and physical properties that are similar to existing materials, and compared to EMD, have enhanced performance. By using material that is relatively abundant, has a low toxicity, and which has established manufacturing infrastructure, a rechargeable Zn|MnO₂ battery may be economically produced which is economically competitive to current rechargeable battery alternatives, such as lithium-ion batteries.

Therefore, the present invention may be characterized, in at least one aspect, as providing a unique mixed metal manganese oxide material which may be processed to facilitate the storage of electrical energy—specifically to form a cathode in a battery. The mixed metal manganese oxide material comprises a homogenous mixture characterized by the formula:

MₓMn₁₋ₓO_{y}D_{d}, [Chemical Formula 1]

wherein “M” represents at least two metals selected from a group consisting of: cesium, nickel, copper, bismuth, cobalt, magnesium, iron, aluminum, scandium, vanadium, chromium, silver, gold, titanium, and, lead. In Chemical Formula 1, D represents a charge balancing anionic species that may include, for example, fluorine (F⁻), chlorine (Cl⁻), bromine (Br⁻), carbonate (CO₃⁻²), nitrate (NO₃⁻¹), and combinations thereof. In Chemical Formula 1, the sum of the total valance of M+Mn is equal to the sum of y+d. Additionally, “x” in Chemical Formula may vary between of 0.001 to 0.999, or between 0.001 to 0.05, or between 0.001 to 0.03.

In another aspect, the present invention may be characterized as providing a process for producing the mixed metal manganese oxide material of Chemical Formula 1 by forming a slurry reaction mixture containing sources of protic solvent and sources of Mn, and M; reacting the mixture, in the presence of an activator, at elevated temperature and then recovering the poorly crystalline manganese-based mixed metal oxide material. The reaction may be conducted at a temperature of from 50° C. to about 90° C. for a period of time from about 15 minutes to 7 days. The slurry could also be heated in an open vessel, after the period of time, to a second elevated temperature between 100° C. to 250° C.

In another aspect, the present invention may be generally characterized as providing a rechargeable battery comprising a housing, an anode material inside the housing, a cathode material inside the housing and electrically separated from the anode material and an electrolyte in the housing, wherein the cathode material comprises Chemical Formula 1.

Additional aspects, embodiments, and details of the invention, all of which may be combinable in any manner, are set forth in the following detailed description of the invention.

### DESCRIPTION OF THE DRAWINGS

One or more exemplary embodiments of the present invention will be described below in conjunction with the following drawing figures, in which:

FIG. 1 is a representation of the phase transformation which occurs upon cell discharge of a conventional alkaline Zn|MnO₂ battery;

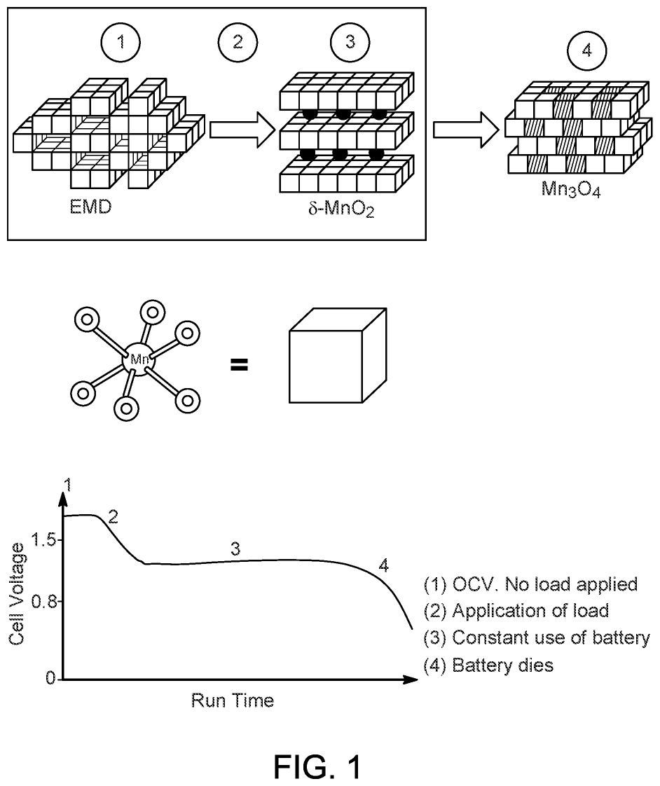

FIG. 2 is a cross sectional view of an embodiment of the battery in a prismatic arrangement; and,

FIG. 3 is an exemplary x-ray diffraction pattern of a composition made according to one or more embodiments of the present invention.

### DETAILED DESCRIPTION OF THE INVENTION

As mentioned above, manganese-based, mixed metal oxides have been invented which are believed to provide a superior material for making a cathode for a rechargeable battery. Rechargeable batteries fabricated using composite cathodes containing the present mixed metal oxides are believed to be capable of thousands of charge-discharge cycles, enabling a safe and economically affordable energy storage system.

Generally, the present mixed metal oxides are best prepared by the dissolution and heat treatment of a soluble manganese salt, such as KMnO₄ with the other metal salts (preferably, nitrates).

With these general principles in mind, one or more embodiments of the present invention will be described with the understanding that the following description is not intended to be limiting.

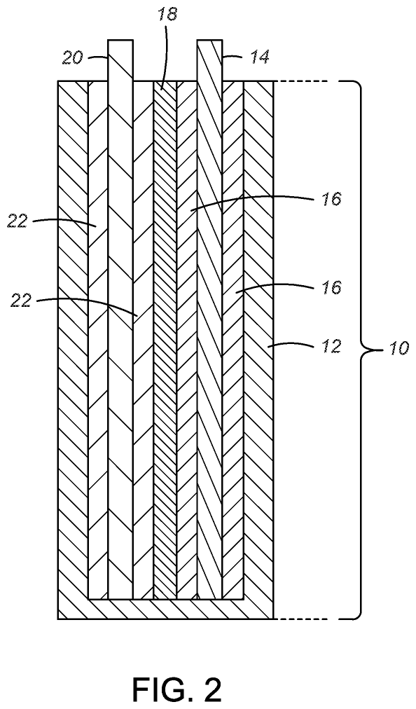

As shown in FIG. 2, a battery 10 according to the present invention may include a housing 12, a cathode current collector 14, a cathode material 16, a separator 18, an anode current collector 20, and an anode material 22. While the battery 10 of FIG. 2 is shown as a prismatic battery arrangement, it is possible that the battery 10 may also be a cylindrical battery.

As is known, dispersed within the housing 12 of the battery 10 is an electrolyte. The electrolyte may be an alkaline electrolyte (e.g., an alkaline hydroxide, such as sodium hydroxide (NaOH), potassium hydroxide (KOH), lithium hydroxide (LiOH), magnesium hydroxide (Mg(OH)₂), calcium hydroxide (Ca(OH)₂), or mixtures thereof).

The cathode current collector 14 and the anode current collector 20 may be a conductive material, for example, nickel, nickel-coated steel, tin-coated steel, silver coated copper, copper plated nickel, nickel plated copper or similar material. The cathode current collector 14, the anode current collector 20, or both may be formed into an expanded mesh, perforated mesh, foil or a wrapped assembly.

The separator 18 may be a polymeric separator (e.g. cellophane, sintered polymer film, or a polyolefin material).

As discussed above, the cathode material 16 of the battery 10 according to the present invention comprises a homogenously mixed metal manganese dioxide (MnO₂). Various metals and metal combinations have been discovered which may be used as the cathode material 16 with the manganese dioxide. Generally, the cathode material 16 includes: manganese oxide and at least two more metals selected from: cesium, nickel, copper, bismuth, cobalt, magnesium, iron, aluminum, scandium, vanadium, chromium, silver, gold, titanium, and, lead. By “homogenously mixed” and similar language it is meant that the metals are relatively evenly disbursed throughout an entire cross section of the material. This is in contrast to, for example, a material that only has some of the metal/metal oxides on the surface of the material.

Thus, a composition of the cathode material 16 has a chemical formula of.

MₓMn₁₋ₓO_{y}D_{d} [Chemical Formula 1].

In Chemical Formula 1, M represents a combination of at least two metals selected from a group consisting of: cesium, nickel, copper, bismuth, cobalt, magnesium, iron, aluminum, scandium, vanadium, chromium, silver, gold, titanium, and, lead. Additionally, “D” in Chemical Formula 1 represents a charge balancing anionic species, for example, fluorine (F⁻), chlorine (Cl⁻), bromine (Br⁻), carbonate (CO₃⁻²), nitrate (NO₃⁻¹), or combinations thereof.

In Chemical Formula 1, a sum of the valance of M+Mn is equal to a sum of y+d. Additionally, ‘x’ may be in the range of 0.001 to 0.999, or between 0.001 to 0.05, or between 0.001 to 0.03. As will be appreciated, these values are in relation to the “1” of Mn in Chemical Formula 1.

The manganese compound may be incorporated into the cathode material 16 as an organic or inorganic salt of manganese (oxidation states 2, 3, 4, 6, or 7+), as a manganese oxide, or as manganese salts in a such as, manganese nitrate, manganese sulfate, manganese chloride, potassium permanganate, sodium permanganate or lithium permanganate.

The additional metals M of Chemical Formula 1 may be incorporated into the cathode material 16 as an organic or inorganic salt. For example, copper may be introduced as a salt of copper (oxidation states 1, 2, 3 or 4), as a copper oxide, or as copper metal (i.e. elemental copper). Exemplary copper compounds are thought to be copper and copper salts such as copper aluminum oxide, copper (I) oxide, copper (II) oxide, and copper salts in a +1, +2, +3, or +4 oxidation state such as, copper nitrate, copper sulfate, and copper chloride. The same applies to the additional metals, with the nitrate salts being preferred.

In some embodiments a binder is used to form the cathode material 16 into a cathode. The binder may be present in a concentration of 0-50 wt %. In one embodiment, the binder comprises water-soluble cellulose-based hydrogels, which were used as thickeners and strong binders, and have been cross-linked with good mechanical strength and with conductive polymers. The binder may also be a cellulose film sold as cellophane. The binders may be formed by physically cross-linking the water-soluble cellulose-based hydrogels with a polymer through repeated cooling and thawing cycles. For example, 0-50 wt % carboxymethyl cellulose (CMC) solution may be cross-linked with 0-50 wt % polyvinyl alcohol (PVA) on an equal volume basis. The binder, compared to the traditionally-used TEFLON®, is thought to have superior performance. TEFLON® is a very resistive material, but its use in the industry has been widespread due to its good rollable properties. This, however, does not rule out using TEFLON® as a binder. Mixtures of TEFLON® with the aqueous binder and some conductive carbon may be used to create rollable binders. The binder may be water-based, is thought to have superior water retention capabilities, adhesion properties, and helps to maintain the conductivity relative to identical cathode using a TEFLON® binder instead. Examples of hydrogels include methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC). Examples of crosslinking polymers include polyvinyl alcohol, polyvinylacetate, polyaniline, polyvinylpyrrolidone, polyvinylidene fluoride and polypyrrole. For example, a 0-50 wt % solution of water-cased cellulose hydrogen may be cross linked with a 0-50 wt % solution of crosslinking polymers by repeated freeze/thaw cycles, radiation treatment or chemical agents (e.g. epichlorohydrin).

The charge balancing anionic species may be incorporated into the cathode material 16 through its addition as part of a salt, with the cation of the salt forming one of the metals in Chemical Formula 1.

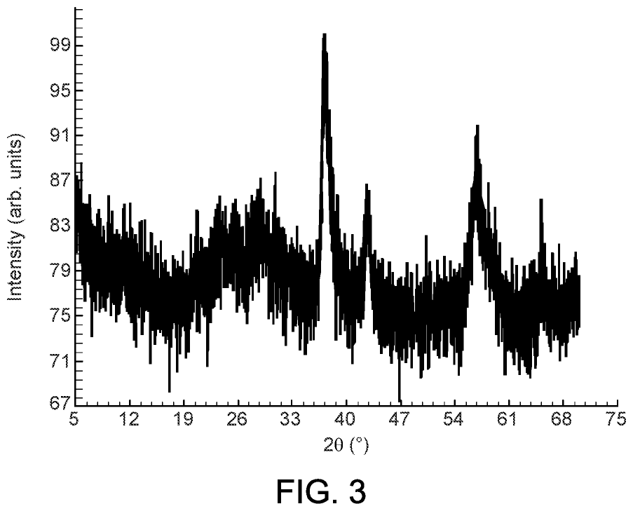

As shown in FIG. 3, a homogenously mixed composition made according to the present application has an x-ray powder diffraction pattern exhibiting peaks at d-spacings and intensities listed in Table A:

TABLE A

| 2θ(°) | d(Å) | I/I₀ (%) |
|---|---|---|
| 23.9 | 3.72 | m |
| 31.6 | 2.82 | m |
| 37.3 | 2.41 | vs |
| 42.8 | 2.11 | m |
| 56.3 | 1.63 | m |

The x-ray powder diffraction patterns presented herein were obtained using standard x-ray powder diffraction techniques. The radiation source was a high-intensity, x-ray tube operated at 40 kV and 40 mA. The diffraction pattern from the copper K-alpha radiation was obtained by appropriate computer-based techniques. Powder samples were pressed flat into a plate and continuously scanned between 5 degrees and 70 degrees (2Θ). Interplanar spacings (d) in Angstrom units were obtained from the position of the diffraction peaks expressed as theta, where theta is the Bragg angle as observed from digitized data. Intensities were determined from the diffraction peak height after subtracting background, “I₀” being the intensity of the strongest line or peak, and “I” being the peak height for each of the other peaks. As will be understood by those skilled in the art the determination of the parameter 2 theta is subject to both human and mechanical error, which in combination can impose an uncertainty of about .+−0.0.4.degree. on each reported value of 2Θ. This uncertainty is also translated to the reported values of the d-spacings, which are calculated from the 2Θ values.

In some of the x-ray patterns reported, the relative intensities of the d-spacings are indicated by the notations s, m, w and vw which represent strong, medium, weak and very weak, respectively. In terms of 100(1/I0), the above designations are defined as: vw=0.01-5, w=5-10, m=10-50, s=50-100, vs=>100.

The present cathode material 16 may be synthesized by mixing manganese nitrate with the other metal nitrates, e.g. cerium nitrate and nickel nitrate, in the targeted metal ratios. An ammonium-based activator such as ammonium hydroxide, ammonium carbonate or ammonium bicarbonate is then added with a small volume of water. The precursors are then mixed together. The resulting slurry can then optionally be digested at a temperature between 50° C. to 90° C. for a time, t, (between 15 mins to 1 week). The slurry may then be transferred to an open vessel and heated to a temperature from 100° C. to 250° C.

The product may then be collected and may be mixed with a conductive carbon, binder, or other additives to be utilized as a cathode within a battery cell.

In the examples which follow elemental analyses were conducted on air dried samples. Analysis was carried out for all elements except oxygen.

### EXAMPLES

### Example 1

A solution was prepared in a 1-liter Teflon® bottle by dissolving Bi(NO₃)₃*5H₂O (0.002 moles, 1.22 g), Cu(NO₃)₂*2.5H₂O (0.005, 1.16 g), Ni(NO₃)₂*6H₂O (0.0005, 1.46 g), and Mn(NO₃)₂*H₂O (0.24 moles, 42.5 g) in deionized (DI) water (0.28 moles, 5 g) at 75° C. Next, (NH₄)₂CO₃ (0.10 moles, 10 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours, then 1° C./min to 170° C. 4 hours, and then 1° C./min to 190° C. for 4 hours. The solid was then filtered and washed with DI water (3×50 ml) after which the material was dried at 100° C. Elemental analysis of the final product determined the composition to be: Bi 0.02; Cu 0.04; Ni 0.03; and Mn.

### Example 2

A solution was prepared in a 1-liter Teflon® bottle by dissolving Bi(NO₃)₃*5H₂O (0.0125 moles, 6.06 g), Ni(NO₃)₂*6H₂O (0.0125, 3.64 g), and Mn(NO₃)₂*H₂O (0.23 moles, 40.26 g) in DI water (0.28 moles, 5 g) and HNO₃ (0.042 moles, 4 grams) at 75° C. Next, (NH₄)₂CO₃ (0.156 moles, 15 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours, then 1° C./min to 170° C. 4 hours, and then 1° C./min to 190° C. for 4 hours. The solid was then filtered and washed with DI water (3×50 ml) after which the material was dried at 100° C. Elemental analysis of the final product determined the composition to be: Ni 0.09; Bi 0.09; and Mn.

### Example 3

A solution was prepared in a 1-liter Teflon® bottle by dissolving Mn(NO₃)₂*H₂O (0.24 moles, 40.26), Pb(NO₃)₂ (0.0125 moles, 4.14 g), and Ni(NO₃)₂*6H₂O (0.0125 moles, 3.63 g) in DI water (0.28 moles, 5 g) at 75° C. Next, (NH₄)₂CO₃ (0.10 moles, 10 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours and then 1° C./min to 170° C. 4 hours. The solid was then filtered and washed with DI water (3×50 ml) after which the material was dried at 100° C. Elemental analysis of the final product determined the composition to be: Pb 0.08; Ni 0.09; and Mn.

### Example 4

A solution was prepared in a 1-liter Teflon® bottle by dissolving Mn(NO₃)₂*H₂O (0.23 moles, 40.26 g), Ni(NO₃)₂*6H₂O (0.0125 moles, 3.63 g), and FeCl₃ (0.0125 moles, 2.03 gmass?) in DI water (0.28 moles, 5 g) at 75° C. Next, (NH₄)₂CO₃ (0.10 moles, 10 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours and then 1° C./min to 170° C. 4 hours. The solid was then filtered and washed with DI water (3×50 ml) after which the material was dried at 100° C. Elemental analysis of the final product determined the composition to be: Fe 0.06; Ni 0.08; and, Mn.

### Example 5

A solution was prepared in a 1-liter Teflon® bottle by dissolving Mn(NO₃)₂*H₂O (0.23 moles, 40.26 g), Pb(NO₃)₂ (0.0125 moles, 4.14 g), Bi(NO₃)₃*5H₂O (0.005 moles, 2.42 g), and Co(NO₃)₂ (0.0125, 3.63 g) in DI water (0.28 moles, 5 g) and HNO₃ (1 ml) at 75° C. Next, (NH₄)₂CO₃ (0.10 moles, 10 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours and then 1° C./min to 170° C. 4 hours. The solid was then filtered and washed with DI water (3×50 ml) after which the material was dried at 100° C. Elemental analysis of the final product determined the composition to be: Pb 0.08; Bi, 0.03, Co 0.072 and Mn.

### Example 6

A solution was prepared in a 1-liter Teflon® bottle by dissolving Mn(NO₃)₂*H₂O (0.23 moles, 40.26 g), Bi(NO₃)₃*5H₂O (0.0125 moles, 6.06 g), and Ce(NO₃)₂*6H₂O (0.0125 moles, 5.43 g) in DI water (0.28 moles, 5 g), and HNO₃ (0.042 moles, 4 gram) at 75° C. Next, (NH₄)₂CO₃ (0.156 moles, 15 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours and then 1° C./min to 170° C. 4 hours. The solid was then filtered and washed with DI water (3×50 ml) after which the material was dried at 100° C. Elemental analysis of the final product determined the composition to be: Ce 0.08; Bi 0.09; and, Mn.

### Example 7

A solution was prepared in a 1-liter Teflon® bottle by dissolving Mn(NO₃)₂*H₂O (0.23 moles, 40.26 g), Bi(NO₃)₃*5H₂O (0.0125 moles, 6.06 g), and AgNO₃ (0.0125 moles, 2.12 grams) in DI water (0.28 moles, 5 g) and HNO₃ (0.042 moles, 4 grams) at 75° C. Next, (NH₄)₂CO₃ (0.156 moles, 15 g) was added to the Teflon® bottle. All reactants were mixed together before the bottle was heated at 75° C. for 48 hours with intermittent venting during the digestion.

After the digestion, the slurry was dried at 100° C. to evaporate the DI water for 24 hours. The remaining solid was transferred to a ceramic dish and heat treated to 1° C./min to 120° C. for 4 hours, 1° C./min to 150° C. for 4 hours and then 1° C./min to 160° C. 4 hours. The solid was then filtered and washed with DI water (3×50 ml) after which the material was dried at 100° C. Elemental analysis of the final product determined the composition to be: Ag 0.07; Bi 0.02; and, Mn.

### Example 8

A solution was prepared in a 1-liter glass beaker by dissolving Mn(NO₃)₂*H₂O (0.23 moles, 40.26 g), Bi(NO₃)₃*5H₂O (0.0125 moles, 6.06 g), and Ni(NO₃)₂*6H₂O (0.0125 moles, 3.63 g) in DI water (0.28 moles, 5 g) and HNO₃ (0.042 moles, 4 grams) at 75° C. with stirring. Next, (NH₄)₂CO₃ (0.156 moles, 15 g) was added and all the reactants were mixed together before the slurry was transfer to a 2-liter static reactor and heated to 150° C. in 2 hours and digested for 16 hours.

Once the reactor was cooled, the remaining solid was transferred to a ceramic dish and heat treated to 1° C./min to 120° C. for 4 hours, 1° C./min to 150° C. for 4 hours and then 1° C./min to 160° C. for 4 hours. The solid was then filtered and washed with DI water (3×50 ml) after which the material was dried at 100° C. Elemental analysis of the final product determined the composition to be: Ni 0.05, Bi 0.03, and Mn.

The present mixed metal oxide materials are believed to provide a material that is suitable as a cathode material in a rechargeable battery.

### Specific Embodiments

While the following is described in conjunction with specific embodiments, it will be understood that this description is intended to illustrate and not limit the scope of the preceding description and the appended claims.

A first embodiment of the invention is a homogenously mixed composition comprising a chemical formula of MₓMn₁₋ₓO_{y}D_{d}, [Chemical Formula 1], wherein M in Chemical Formula 1 represents a combination of at least two metals selected from a group consisting of cesium, nickel, copper, bismuth, cobalt, magnesium, iron, aluminum, scandium, vanadium, chromium, silver, gold, titanium, and, lead; wherein D in Chemical Formula 1 represents a charge balancing anionic species, wherein a sum of a valance of M and Mn is equal to a sum of y and d, wherein ‘x’ is between 0.001 to 0.999, and, wherein the homogenously mixed composition comprises an x-ray powder diffraction pattern exhibiting peaks at d-spacings in Table A:

TABLE A

| 2θ(°) | d(Å) |
|---|---|
| 23.9 | 3.72 |
| 31.6 | 2.82 |
| 37.3 | 2.41 |
| 42.8 | 2.11 |
| 56.3 | 1.63 |

An embodiment of the invention is one, any or all of prior embodiments in this paragraph up through the first embodiment in this paragraph, wherein M in Chemical Formula 1 represents a combination of at least two metals selected from a group consisting of cesium, nickel, copper, bismuth, cobalt, magnesium, iron, and, lead. An embodiment of the invention is one, any or all of prior embodiments in this paragraph up through the first embodiment in this paragraph, wherein M represents bismuth and at least one other metal selected from a group consisting of cesium, nickel, copper, cobalt, magnesium, iron, aluminum, scandium, vanadium, chromium, silver, gold, titanium, and, lead. An embodiment of the invention is one, any or all of prior embodiments in this paragraph up through the first embodiment in this paragraph, wherein M represents nickel and at least one other metal selected from a group consisting of cesium, bismuth, copper, cobalt, magnesium, iron, aluminum, scandium, vanadium, chromium, silver, gold, titanium, and, lead. An embodiment of the invention is one, any or all of prior embodiments in this paragraph up through the first embodiment in this paragraph, wherein M represents copper and at least one other metal selected from a group consisting of cesium, bismuth, nickel, cobalt, magnesium, iron, aluminum, scandium, vanadium, chromium, silver, gold, titanium, and, lead. An embodiment of the invention is one, any or all of prior embodiments in this paragraph up through the first embodiment in this paragraph, wherein the charge balancing anionic species is selected from the group consisting of fluorine (F⁻), chlorine (Cl⁻), bromine (Br⁻), carbonate (CO₃⁻²), and nitrate (NO₃⁻¹).

A second embodiment of the invention is a rechargeable battery comprising a housing; an anode material inside the housing; a cathode material inside the housing and electrically separated from the anode material; and, an electrolyte in the housing, wherein the cathode material comprises a chemical formula of MₓMn₁₋ₓO_{y}D_{d}, [Chemical Formula 1], wherein M in Chemical Formula 1 is a combination of at least two metals selected from a group consisting of cesium, nickel, copper, bismuth, cobalt, magnesium, iron, aluminum, scandium, vanadium, chromium, silver, gold, titanium, and, lead; wherein D in Chemical Formula 1 is a charge balancing anionic species, wherein a sum of a valance of M and Mn is equal to a sum of y and d, and, wherein ‘x’ is between 0.001 to 0.999, and, wherein the cathode material comprises an x-ray powder diffraction pattern exhibiting peaks at d-spacings listed from Table A:

TABLE A

| 2θ(°) | d(Å) |
|---|---|
| 23.9 | 3.72 |
| 31.6 | 2.82 |
| 37.3 | 2.41 |
| 42.8 | 2.11 |
| 56.3 | 1.63 |

An embodiment of the invention is one, any or all of prior embodiments in this paragraph up through the second embodiment in this paragraph, wherein M in Chemical Formula 1 represents a combination of at least two metals selected from a group consisting of cesium, nickel, copper, bismuth, cobalt, magnesium, iron, and, lead. An embodiment of the invention is one, any or all of prior embodiments in this paragraph up through the second embodiment in this paragraph, wherein M represents bismuth and at least one other metal selected from a group consisting of cesium, nickel, copper, cobalt, magnesium, iron, aluminum, scandium, vanadium, chromium, silver, gold, titanium, and, lead. An embodiment of the invention is one, any or all of prior embodiments in this paragraph up through the second embodiment in this paragraph, wherein M represents nickel and at least one other metal selected from a group consisting of cesium, bismuth, copper, cobalt, magnesium, iron, aluminum, scandium, vanadium, chromium, silver, gold, titanium, and, lead. An embodiment of the invention is one, any or all of prior embodiments in this paragraph up through the second embodiment in this paragraph, wherein M represents copper and at least one other metal selected from a group consisting of cesium, bismuth, nickel, cobalt, magnesium, iron, aluminum, scandium, vanadium, chromium, silver, gold, titanium, and, lead. An embodiment of the invention is one, any or all of prior embodiments in this paragraph up through the second embodiment in this paragraph, wherein the charge balancing anionic species is selected from the group consisting of fluorine (F⁻), chlorine (Cl⁻), bromine (Br⁻), carbonate (CO₃⁻²), and nitrate (NO₃⁻¹).

A third embodiment of the invention is a method for forming a composition having a chemical formula of MₓMn₁₋ₓO_{y}D_{d}, [Chemical Formula 1], a combination of at least two metals selected from a group consisting of cesium, nickel, copper, bismuth, cobalt, magnesium, iron, aluminum, scandium, vanadium, chromium, silver, gold, titanium, and, lead, wherein D in Chemical Formula 1 is a charge balancing anionic species, wherein a sum of a valance of M and Mn in Chemical Formula 1 is equal to a sum of y and d, and, wherein ‘x’ in Chemical Formula 1 is between 0.001 to 0.999, the method comprising forming a slurry mixture comprising a protic solvent, a source of Mn, and a source of each metal represented by M in Chemical Formula 1; reacting the slurry mixture at an elevated temperature in a presence of an ammonia-based activator; and, recovering a material comprising the composition from the slurry mixture after reacting the slurry mixture at the elevated temperature in the presence of the ammonia-based activator. An embodiment of the invention is one, any or all of prior embodiments in this paragraph up through the third embodiment in this paragraph, wherein the source of Mn is a nitrate salt. An embodiment of the invention is one, any or all of prior embodiments in this paragraph up through the third embodiment in this paragraph, wherein the source of at least one of metal represented by M Chemical Formula 1 is a nitrate salt. An embodiment of the invention is one, any or all of prior embodiments in this paragraph up through the third embodiment in this paragraph, wherein the ammonia-based activator is selected from a group consisting of ammonium hydroxide, ammonium carbonate, and ammonium bicarbonate. An embodiment of the invention is one, any or all of prior embodiments in this paragraph up through the third embodiment in this paragraph, further comprising digesting the slurry mixture at a temperature between 50° C. to 90° C. before reacting the slurry mixture at an elevated temperature. An embodiment of the invention is one, any or all of prior embodiments in this paragraph up through the third embodiment in this paragraph, wherein the elevated temperature is between 100° C. to 250° C.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A homogenously mixed composition comprising:
a chemical formula of:
MₓMn₁₋ₓO_{y}D_{d}, [Chemical Formula 1],
wherein M in Chemical Formula 1 represents a combination of at least two metals selected from a group consisting of: cesium, nickel, copper, bismuth, cobalt, magnesium, iron, aluminum, scandium, vanadium, chromium, silver, gold, titanium, and, lead;
wherein D in Chemical Formula 1 represents a charge balancing anionic species,
wherein a sum of a valance of M and Mn is equal to a sum of y and d,
wherein ‘x’ is between 0.001 to 0.999, and,
wherein the homogenously mixed composition comprises an x-ray powder diffraction pattern exhibiting peaks at d-spacings in Table A:
TABLE A

| 2θ(°) | d(Å) |
|---|---|
| 23.9 | 3.72 |
| 31.6 | 2.82 |
| 37.3 | 2.41 |
| 42.8 | 2.11 |
| 56.3 | 1.63 |

2. The homogenously mixed composition of claim 1,
wherein M in Chemical Formula 1 represents a combination of at least two metals selected from a group consisting of: cesium, nickel, copper, bismuth, cobalt, magnesium, iron, and, lead.

3. The homogenously mixed composition of claim 1,
wherein M represents bismuth and at least one other metal selected from a group consisting of: cesium, nickel, copper, cobalt, magnesium, iron, aluminum, scandium, vanadium, chromium, silver, gold, titanium, and, lead.

4. The homogenously mixed composition of claim 1,
wherein M represents nickel and at least one other metal selected from a group consisting of: cesium, bismuth, copper, cobalt, magnesium, iron, aluminum, scandium, vanadium, chromium, silver, gold, titanium, and, lead.

5. The homogenously mixed composition of claim 1,
wherein M represents copper and at least one other metal selected from a group consisting of: cesium, bismuth, nickel, cobalt, magnesium, iron, aluminum, scandium, vanadium, chromium, silver, gold, titanium, and, lead.

6. The homogenously mixed composition of claim 1,
wherein the charge balancing anionic species is selected from the group consisting of: fluorine (F⁻), chlorine (Cl⁻), bromine (Br⁻), carbonate (CO₃⁻²), and nitrate (NO₃⁻¹).

7. A rechargeable battery comprising:
a housing;
an anode material inside the housing;
a cathode material inside the housing and electrically separated from the anode material; and,
an electrolyte in the housing,
wherein the cathode material comprises a chemical formula of:
MₓMn₁₋ₓO_{y}D_{d}, [Chemical Formula 1],
wherein M in Chemical Formula 1 is a combination of at least two metals selected from a group consisting of: cesium, nickel, copper, bismuth, cobalt, magnesium, iron, aluminum, scandium, vanadium, chromium, silver, gold, titanium, and, lead;
wherein D in Chemical Formula 1 is a charge balancing anionic species,
wherein a sum of a valance of M and Mn is equal to a sum of y and d, and,
wherein ‘x’ is between 0.001 to 0.999, and,
wherein the cathode material comprises an x-ray powder diffraction pattern exhibiting peaks at d-spacings listed in Table A:
TABLE A

| 2θ(°) | d(Å) |
|---|---|
| 23.9 | 3.72 |
| 31.6 | 2.82 |
| 37.3 | 2.41 |
| 42.8 | 2.11 |
| 56.3 | 1.63 |

8. The rechargeable battery of claim 7,
wherein M in Chemical Formula 1 represents a combination of at least two metals selected from a group consisting of: cesium, nickel, copper, bismuth, cobalt, magnesium, iron, and, lead.

9. The rechargeable battery of claim 7,
wherein M represents bismuth and at least one other metal selected from a group consisting of: cesium, nickel, copper, cobalt, magnesium, iron, aluminum, scandium, vanadium, chromium, silver, gold, titanium, and, lead.

10. The rechargeable battery of claim 7,
wherein M represents nickel and at least one other metal selected from a group consisting of: cesium, bismuth, copper, cobalt, magnesium, iron, aluminum, scandium, vanadium, chromium, silver, gold, titanium, and, lead.

11. The rechargeable battery of claim 7,
wherein M represents copper and at least one other metal selected from a group consisting of: cesium, bismuth, nickel, cobalt, magnesium, iron, aluminum, scandium, vanadium, chromium, silver, gold, titanium, and, lead.

12. The rechargeable battery of claim 7,
wherein the charge balancing anionic species is selected from the group consisting of: fluorine (F⁻), chlorine (Cl⁻), bromine (Br⁻), carbonate (CO₃⁻²), and nitrate (NO₃⁻¹).

13. A method for forming a composition having a chemical formula of
MₓMn₁₋ₓO_{y}D_{d}, [Chemical Formula 1],
wherein M in Chemical Formula 1 represents a combination of at least two metals selected from a group consisting of cesium, nickel, copper, bismuth, cobalt, magnesium, iron, aluminum, scandium, vanadium, chromium, silver, gold, titanium, and, lead, wherein D in Chemical Formula 1 is a charge balancing anionic species, wherein a sum of a valance of M and Mn in Chemical Formula 1 is equal to a sum of y and d, and, wherein ‘x’ in Chemical Formula 1 is between 0.001 to 0.999, the method comprising:
forming a slurry mixture comprising a protic solvent, a source of Mn, and a source of each metal represented by M in Chemical Formula 1;
reacting the slurry mixture at an elevated temperature in a presence of an ammonia-based activator; and,
recovering a material comprising the composition from the slurry mixture after reacting the slurry mixture at the elevated temperature in the presence of the ammonia-based activator.

14. The method of claim 13,
wherein the source of Mn is a nitrate salt.

15. The method of claim 13,
wherein the source of at least one of metal represented by M Chemical Formula 1 is a nitrate salt.

16. The method of claim 13,
wherein the ammonia-based activator is selected from a group consisting of: ammonium hydroxide, ammonium carbonate, and ammonium bicarbonate.

17. The method of claim 13, further comprising:
digesting the slurry mixture at a temperature between 50° C. to 90° C. before reacting the slurry mixture at an elevated temperature.

18. The method of claim 17,
wherein the elevated temperature is between 100° C. to 250° C.

19. The method of claim 13, wherein M represents bismuth and at least one other metal selected from a group consisting of: cesium, nickel, copper, cobalt, magnesium, iron, aluminum, scandium, vanadium, chromium, silver, gold, titanium, and, lead.

20. The method of claim 13, wherein M represents nickel and at least one other metal selected from a group consisting of: cesium, bismuth, copper, cobalt, magnesium, iron, aluminum, scandium, vanadium, chromium, silver, gold, titanium, and, lead.
